(19) United States
(12) Patent Application Publication
(10) Pub. No.: US 2007/0205367 A1
(43) Pub. Date: Sep. 6, 2007

(54) Apparatus and method for hybrid computed tomography imaging

(75) Inventors: Bruno Kristiian Bernard Deman, Clifton Park, NY (US); Peter Michael Edic, Albany, NY (US); James Walter Leblanc, Niskayuna, NY (US); John Eric Tkaczyk, Delanson, NY (US); Jonathan David Short, Saratoga Springs, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/365,791

(22) Filed: Mar. 1, 2006

(51) Int. Cl. G01T 1/161

(52) U.S. Cl. 250/363.02; 378/19; 250/366

(57) ABSTRACT

A system is presented. The system includes a plurality of energy integrating detector elements configured to acquire energy integrating data. Further, the system includes a plurality of energy discriminating detector elements configured to acquire energy discriminating data, where the plurality of energy integrating detector elements and the plurality of energy discriminating detector elements are arranged in a spatial relationship to form a hybrid detector, and where the plurality of energy integrating detector elements and the plurality of energy discriminating detector elements are configured to obtain respective sets of energy integrating data and energy discriminating data for use in generating an image.

### BACKGROUND

The invention relates generally to apparatus and methods for imaging for differentiating material characteristics, and more specifically to differentiating material characteristics using a hybrid imaging system.

In X-ray computed tomography (CT), cross-sectional images are generated of a scanned object. The values in the images represent the linear attenuation coefficient of the underlying tissue. As will be appreciated, the linear attenuation coefficient may be defined as a product of mass attenuation coefficient and density of the underlying tissue. Additional information may be obtained by not only reconstructing the degree of attenuation, but also the energy dependence of the attenuation. This type of information is much more material specific, and allows a user to distinguish between different materials with similar linear attenuation coefficients (i.e., the product of mass attenuation coefficient and density is comparable for both materials). In order to reduce the number of degrees of freedom, the energy-dependent attenuation is decomposed into a limited number of basis functions (typically Compton effect and photon-electric effect; or material 1 and material 2, etc.).

Previously conceived techniques employed dual or multiple energy techniques to facilitate material decomposition, which was achieved by acquiring projection data sets at two or more X-ray source voltages and/or different filtration. A more advanced technique is to use energy discrimination detectors, such as photon-counting detectors with multiple energy bins. However, the use of photon counting detectors suffers from limitations such as limited count rate capability (e.g., a few MHz/detector pixel), which limits the total X-ray flux rate, and hence the image quality, that may be obtained within a limited acquisition time interval. Additionally, the decomposition into different basis functions typically results in noise amplification in the images. Furthermore, the presence of scatter may cause error in the decomposition results.

There is therefore a need for an imaging system capable of energy discrimination and energy integration. In particular, there is a significant need for a design of a hybrid detector capable of energy discrimination and energy integration.

### BRIEF DESCRIPTION

Briefly, in accordance with aspects of the present technique, a system is presented. The system includes a plurality of energy integrating detector elements configured to acquire energy integrating data. Further, the system includes a plurality of energy discriminating detector elements configured to acquire energy discriminating data, where the plurality of energy integrating detector elements and the plurality of energy discriminating detector elements are arranged in a spatial relationship to form a hybrid detector, and where the plurality of energy integrating detector elements and the plurality of energy discriminating detector elements are configured to obtain respective sets of energy integrating data and energy discriminating data for use in generating an image.

In accordance with another aspect of the present technique, a detector module is presented. The detector module includes a plurality of detector assemblies disposed on an interconnection substrate.

In accordance with yet another aspect of the present technique, a detector module is presented. The detector module includes a first layer comprising a plurality of energy integrating detector elements disposed on a first substrate, where the plurality of energy integrating detector elements is configured to acquire energy integrating data. The detector module also includes a second layer comprising a filtering element disposed adjacent the first layer, where the filtering element is configured to attenuate X-ray spectra. Furthermore, the detector module includes a third layer comprising a plurality of energy discriminating detector elements disposed adjacent the second layer and disposed on a second substrate, where the plurality of energy discriminating detector elements is configured to acquire energy discriminating data.

In accordance with further aspects of the present technique, a method of imaging is presented. The method includes obtaining energy integrating image data from a plurality of energy integrating detector elements. Additionally, the method includes obtaining energy discriminating image data from a plurality of energy discriminating detector elements. The method also includes combining the energy integrating image data and the energy discriminating image data to form combined image data, where the plurality of energy integrating detector elements and the plurality of energy discriminating detector elements are arranged in a spatial relationship to form a hybrid detector, and where the plurality of energy integrating detector elements and the plurality of energy discriminating detector elements are configured to obtain respective sets of energy integrating data and energy discriminating data for use in generating an image.

In accordance with another aspect of the present technique, an imaging system is presented. The imaging system includes one or more sources of radiation configured to emit a stream of radiation toward a patient to be scanned. Furthermore, the imaging system includes a computer configured to generate images with enhanced image quality and to provide tissue composition information. The imaging system also includes a detector assembly configured to detect the stream of radiation and to generate one or more signals responsive to the stream of radiation, where the detector assembly includes a plurality of energy integrating detector elements configured to acquire energy integrating data and a plurality of energy discriminating detector elements configured to acquire energy discriminating data, where the plurality of energy integrating detector elements and the plurality of energy discriminating detector elements are arranged in a spatial relationship to form a hybrid detector, and where the plurality of energy integrating detector elements and the plurality of energy discriminating detector elements are configured to obtain respective sets of energy integrating data and energy discriminating data for use in generating an image. In addition, the imaging system includes a system controller configured to control the rotation of the one or more sources of radiation and the detector assembly and to control the acquisition of one or more sets of projection data from the detector assembly via a data acquisition system. The imaging system also includes a computer system operationally coupled to the one or more sources of radiation and the detector assembly, where the computer system is configured to receive the one or more sets of projection data.

### DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an exemplary imaging system in the form of a CT imaging system for use in producing processed images, in accordance with aspects of the present technique;

FIG. 2 is a sectional perspective view of a gantry of the exemplary imaging system illustrated in FIG. 1, in accordance with aspects of the present technique;

FIG. 3 is a perspective view of an asymmetric detector arc, in accordance with aspects of the present technique;

FIG. 4 is a perspective view of a combined detector arc, in accordance with aspects of the present technique;

FIG. 5 is a perspective view of another embodiment of a combined detector arc, in accordance with aspects of the present technique;

FIG. 6 is a perspective view of yet another embodiment of a combined detector arc, in accordance with aspects of the present technique;

FIG. 7 is a cross-sectional side view of a detector module illustrating an arrangement of detector elements, in accordance with aspects of the present technique;

FIG. 8 is a cross-sectional side view of another detector module illustrating an alternate arrangement of detector elements, in accordance with aspects of the present technique;

FIG. 9 is a cross-sectional side view of a detector module illustrating yet another exemplary arrangement of detector elements, in accordance with aspects of the present technique;

FIG. 10 is a perspective view of a detector module having detector elements arranged in a cross-shaped configuration, in accordance with aspects of the present technique;

FIG. 11 is a cross-sectional view of an exemplary arrangement of detector elements for use in a stationary computed tomography (sCT) system, in accordance with aspects of the present technique;

FIG. 12 is an exploded view of an assembly for use in a detector module, in accordance with aspects of the present technique;

FIG. 13 is an exploded view of a detector module, in accordance with aspects of the present technique;

FIG. 14 is a perspective view of a detector module having a plurality of energy discriminating detector elements disposed in a Z-direction, in accordance with aspects of the present technique;

FIG. 15 is a perspective view of a detector module having a plurality of energy discriminating detector elements disposed in a X-direction, in accordance with aspects of the present technique;

FIG. 16 is a perspective view of a detector module having a plurality of energy discriminating detector elements disposed in a X-direction and a Z-direction, in accordance with aspects of the present technique;

FIGS. 17-18 are perspective views illustrating interlacing of the plurality of energy integrating detector elements and the plurality of energy discriminating detector elements with wire bond interconnect, in accordance with aspects of the present technique;

FIG. 19 is a top view of an interposer used in the detector module illustrated in FIG. 14, in accordance with aspects of the present technique;

FIG. 20 is a perspective view of a detector module including an interposer having through-via interconnect, in accordance with aspects of the present technique;

FIG. 21 is a top view of the interposer of FIG. 20, in accordance with aspects of the present technique; and

FIG. 22 is an exploded view of a detector module having a layered structure, in accordance with aspects of the present technique.

### DETAILED DESCRIPTION

Conventional CT detectors typically produce an electronic signal I that is proportional to a total amount of absorbed X-ray energy in each view. The electronic signal I may be given by:

$$I ≅ {\sum }_{K} {N}_{K} {E}_{K} \qquad ( 1 )$$

where N_{K} is representative of the number of detected X-ray photons with energy E_{K}.

Consequently, the signal I does not contain any information regarding energy distribution of the individual photons. This mode of detection is generally referred to as “energy integrating” detection and detectors configured for such operation are generally referred to as energy integrating detectors with proportional energy weighting.

Further, a different type of detector, called a photon counting detector without energy discrimination, may be configured to measure a value proportional to the total number of photons N absorbed in each view. It may be noted that in this type of detector, the photons are uniformly weighted irrespective of energies before summation. The electronic signal I may be given by:

$$I ≅ {\sum }_{K} {N}_{K} \qquad ( 2 )$$

Such a detector is generally referred to as an energy integrating detector with equal energy weighting. The signal I in such a detector does not contain any information regarding energy distribution of the individual photons. It may be noted that energy integrating (EI) detectors with proportional or equal energy weighting may be considered as one class of detectors. This class of energy integrating detectors does not provide energy discrimination information.

Alternately, a detector may be configured to preferentially weight the number of photons within two or more energy intervals. This mode of detection is generally referred to as “energy discriminating” detection. Energy discriminating (ED) detectors may be implemented in different ways including the use of photon counting detectors with multiple energy bins.

Energy discriminating detectors provide some information regarding the energy distribution of the detected photons. These detectors may produce two or more signals corresponding to two or more energy intervals. The energy intervals may include a high energy signal and a low energy signal, for example. Accordingly, for a detector with two energy bins and energy weighting factors L_{K} and H_{K} the corresponding low energy and high energy signals may be given most generally by:

$${I}_{low} = {\sum }_{low} {N}_{K} {L}_{K} \\ and \\ {I}_{high} = {\sum }_{high} {N}_{K} {H}_{K} \qquad ( 3 )$$

where N_{K} is representative of the number of detected X-ray photons with energy E_{K}.

Furthermore, for a photon counting energy discriminating detector having a plurality of energy bins, the weight factors may be chosen to be identical for all energies. Accordingly, the signal I may be represented by:

$${I}_{BIN} = {\sum }_{K ∈ BIN} {N}_{K} \qquad ( 4 )$$

where each bin corresponds to a different energy interval.

Such photon counting energy discriminating detectors may saturate at high photon count rate and therefore operate correctly only within a limited dynamic range of X-ray flux rate. This additional information regarding the energy may be employed to advantageously reduce beam-hardening artifacts and more importantly to obtain more material-specific information.

Furthermore, conventional CT produces a CT number for each voxel. The CT number is typically the linear attenuation coefficient μre-scaled relative to the linear attenuation coefficients of vacuum and water. However, as will be appreciated, the linear attenuation coefficient is also a function of energy μ(E). Therefore, each reconstructed value may be representative of an effective linear attenuation coefficient μ_{eff} which is a weighted average of μ(E) over the used X-ray energy range. However, employing this approximation results in beam-hardening artifacts and eliminates the capability to identify two materials having similar average attenuation characteristics. Energy discriminating detectors may be employed to overcome the shortcomings discussed hereinabove. The energy discriminating detectors facilitate obtaining measurements over multiple energy intervals that provide extra information that may be necessary to reconstruct any extra unknowns.

A hybrid detector is a detector that advantageously includes energy integrating detector elements and energy discriminating detector elements. The energy integrating detector elements facilitate detecting a large number of photons, while the energy discriminating detector elements facilitate capturing additional information based on the energy-dependency of the attenuation. As will be described in detail hereinafter, a hybrid detector in accordance with exemplary aspects of the present technique is presented. As will be appreciated by one skilled in the art, the figures are for illustrative purposes and are not drawn to scale. Additionally, although, the exemplary embodiments illustrated hereinafter are described in the context of X-ray CT, it will be appreciated that use of the exemplary embodiments in emission tomography, such as Positron Emission Tomography (PET) and Single Photon Emission Computed Tomography (SPECT) are also contemplated in conjunction with the present technique. Furthermore, although, the exemplary embodiments illustrated hereinafter are described in the context of a medical imaging system, it will be appreciated that use of the exemplary embodiments in industrial applications, such as, but not limited to, explosive detection systems, luggage scanning systems and non-destructive evaluation systems are also contemplated in conjunction with the present technique.

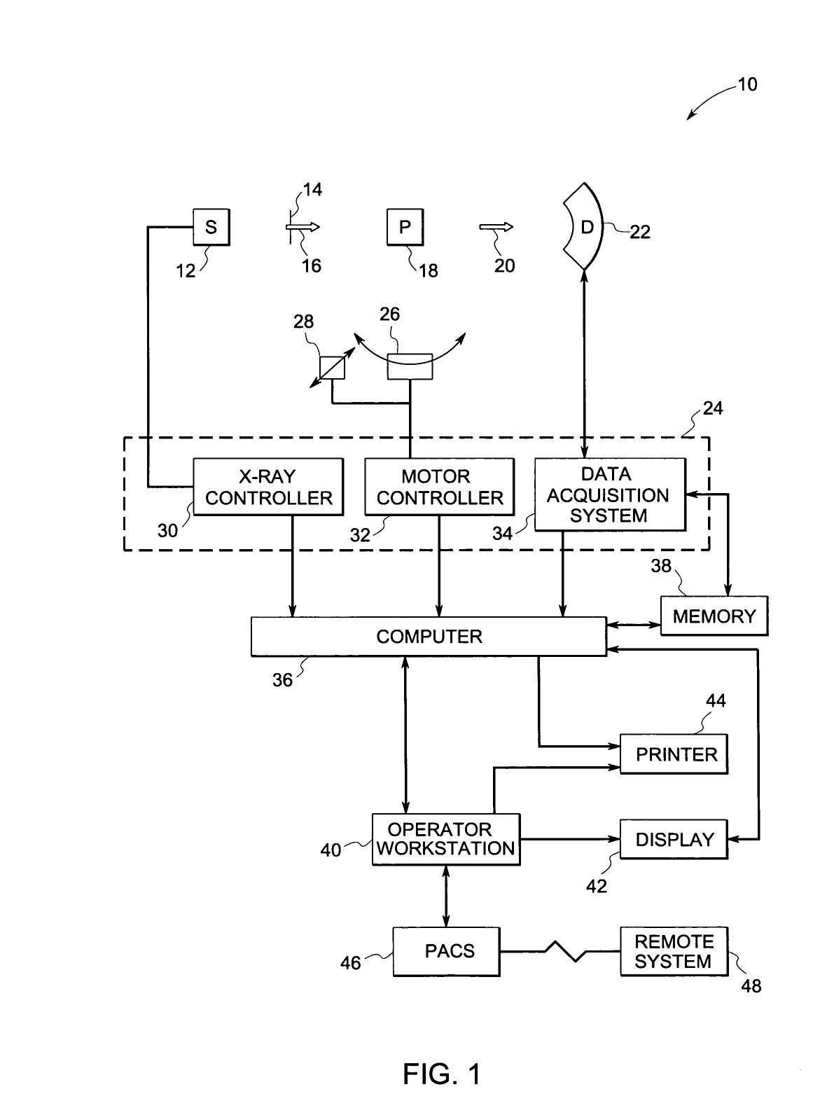

FIG. 1 is a block diagram showing an imaging system 10 for acquiring and processing image data in accordance with the present technique. In the illustrated embodiment, the system 10 is a computed tomography (CT) system designed to acquire X-ray projection data, to reconstruct the projection data into an image, and to process the image data for display and analysis in accordance with the present technique. In the embodiment illustrated in FIG. 1, the imaging system 10 includes a source of X-ray radiation 12. In one exemplary embodiment, the source of X-ray radiation 12 is an X-ray tube. The source of X-ray radiation 12 may include one or more thermionic or solid-state electron emitters directed at an anode to generate X-rays or, indeed, any other device capable of generating X-rays having a spectrum and energy useful for imaging a desired object. Examples of suitable electron emitters include tungsten filament, tungsten plate, field emitter, thermal field emitter, dispenser cathode, thermionic cathode, photo-emitter, and ferroelectric cathode.

The source of radiation 12 may be positioned near a collimator 14, which may be configured to shape a stream of radiation 16 that is emitted by the source of radiation 12. The stream of radiation 16 passes into the imaging volume containing the subject to be imaged, such as a human patient 18. The stream of radiation 16 may be generally fan-shaped or cone-shaped, depending on the configuration of the detector array, discussed below, as well as the desired method of data acquisition. A portion 20 of radiation passes through or around the subject and impacts a detector array, represented generally at reference numeral 22. Detector elements of the array produce electrical signals that represent the intensity of the incident X-ray beam. These signals are acquired and processed to reconstruct an image of the features within the subject.

The radiation source 12 is controlled by a system controller 24, which furnishes both power, and control signals for CT examination sequences. Moreover, the detector 22 is coupled to the system controller 24, which commands acquisition of the signals generated in the detector 22. The system controller 24 may also execute various signal processing and filtration functions, such as for initial adjustment of dynamic ranges, interleaving of digital image data, and so forth. In general, system controller 24 commands operation of the imaging system to execute examination protocols and to process acquired data. In the present context, system controller 24 also includes signal processing circuitry, typically based upon a general purpose or application-specific digital computer, associated memory circuitry for storing programs and routines executed by the computer, as well as configuration parameters and image data, interface circuits, and so forth.

In the embodiment illustrated in FIG. 1, the system controller 24 is coupled via a motor controller 32 to a rotational subsystem 26 and a linear positioning subsystem 28. In one embodiment, the rotational subsystem 26 enables the X-ray source 12, the collimator 14 and the detector 22 to be rotated one or multiple turns around the patient 18. In other embodiments, the rotational subsystem 26 may rotate only one of the source 12 or the detector 22 while the system controller 24 may differentially activate various stationary electron emitters to generate X-ray radiation if the detector 22 is rotated and/or detector elements arranged in a ring about the imaging volume if the source 12 is rotated. In yet another embodiment both the source 12 and the detector 22 may remain stationary. In embodiments in which the source 12 and/or detector 22 are rotated, the rotational subsystem 26 may include a gantry. Thus, the system controller 24 may be utilized to operate the gantry. The linear positioning subsystem 28 enables the patient 18, or more specifically a patient table, to be displaced linearly. Thus, the patient table may be linearly moved within the gantry to generate images of particular areas of the patient 18.

Additionally, as will be appreciated by those skilled in the art, the source of radiation 12 may be controlled by an X-ray controller 30 disposed within the system controller 24. Particularly, the X-ray controller 30 is configured to provide power and timing signals to the X-ray source 12.

Further, the system controller 24 is also illustrated comprising a data acquisition system 34. In this exemplary embodiment, the detector 22 is coupled to the system controller 24, and more particularly to the data acquisition system 34. The data acquisition system 34 receives data collected by readout electronics of the detector 22. The data acquisition system 34 typically receives sampled analog signals from the detector 22 and converts the data to digital signals for subsequent processing by a computer 36.

The computer 36 typically is coupled to or incorporates the system controller 24. The data collected by the data acquisition system 34 may be transmitted to the computer 36 for subsequent processing and reconstruction, or stored directly to memory 38. The computer 36 may comprise or communicate with a memory 38 that can store data processed by the computer 36 or data to be processed by the computer 36. It should be understood that any type of memory configured to store a large amount of data might be utilized by such an exemplary system 10. Moreover, the memory 38 may be located at the acquisition system or may include remote components, such as network accessible memory media, for storing data, processing parameters, and/or routines for implementing the techniques described below.

The computer 36 may also be adapted to control features such as scanning operations and data acquisition that may be enabled by the system controller 24. Furthermore, the computer 36 may be configured to receive commands and scanning parameters from an operator via an operator workstation 40, which is typically equipped with a keyboard and other input devices (not shown). An operator may thereby control the system 10 via the input devices. Thus, the operator may observe the reconstructed image and other data relevant to the system from computer 36, initiate imaging, and so forth.

A display 42 coupled to the operator workstation 40 may be utilized to observe the reconstructed images. Additionally, the scanned image may also be printed by a printer 44, which may be coupled to the operator workstation 40. The display 42 and printer 44 may also be connected to the computer 36, either directly or via the operator workstation 40. The operator workstation 40 may also be coupled to a picture archiving and communications system (PACS) 46. It should be noted that PACS 46 might be coupled to a remote system 48, such as radiology department information system (RIS), hospital information system (HIS) or to an internal or external network, so that others at different locations may gain access to the image data.

It should be further noted that the computer 36 and operator workstation 40 may be coupled to other output devices, which may include standard or special purpose computers and associated processing circuitry. One or more operator workstations 40 may be further linked in the system for outputting system parameters, requesting examinations, viewing images, and so forth. In general, displays, printers, workstations, and similar devices supplied within the system may be local to the data acquisition components, or may be remote from these components, such as elsewhere within an institution or hospital, or in an entirely different location, linked to the image acquisition system via one or more configurable networks, such as the Internet, a virtual private network or the like.

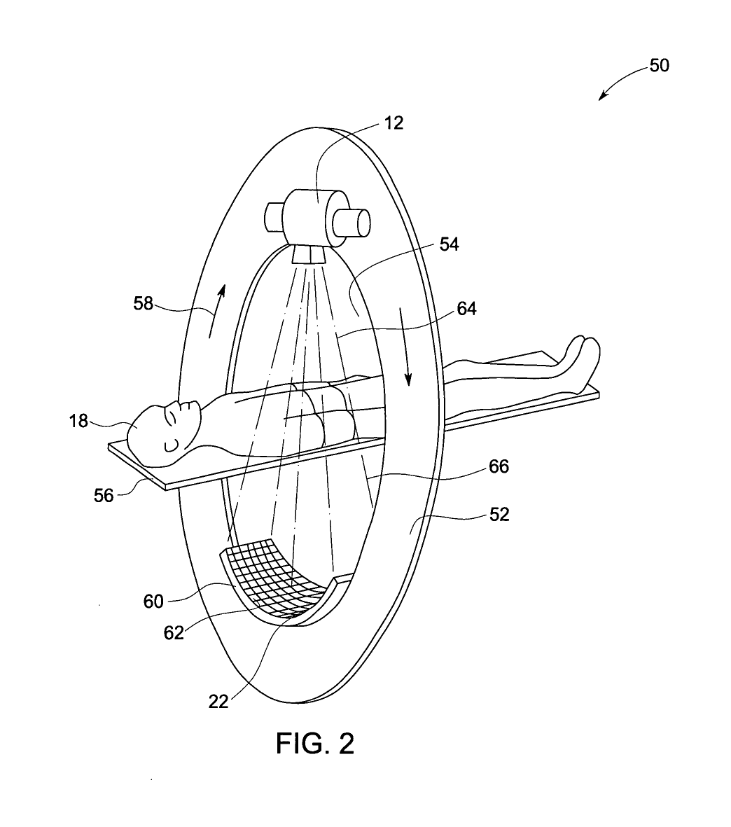

As noted above, an exemplary imaging system utilized in a present embodiment may be a CT scanning system 50, as depicted in greater detail in FIG. 2. The CT scanning system 50 may be a multi-slice CT (MSCT) system that offers a wide axial coverage, high rotational speed of the gantry, and high spatial resolution. Alternately, the CT scanning system 50 may be a volumetric CT (VCT) system utilizing a cone-beam geometry and an area detector to allow the imaging of a volume, such as an entire internal organ of a subject, at high or low gantry rotational speeds. The CT scanning system 50 is illustrated with a gantry 52 that has an aperture 54 through which a patient 18 may be moved. A patient table 56 may be positioned in the aperture 54 of the gantry 52 to facilitate movement of the patient 18, typically via linear displacement of the table 56 by the linear positioning subsystem 28 (see FIG. 1). The gantry 52 is illustrated with the source of radiation 12, such as an X-ray tube that emits X-ray radiation from a focal point. For cardiac imaging, the stream of radiation is directed towards a cross section of the patient 18 including the heart.

In typical operation, the X-ray source 12 projects an X-ray beam 64 from the focal point and toward detector array 22. The collimator 14 (see FIG. 1), such as lead or tungsten shutters, typically defines the size and shape of the X-ray beam that emerges from the X-ray source 12. The detector 22 is generally formed by a plurality of detector elements, which detect the X-rays that pass through and around a subject of interest, such as the heart or chest. Each detector element produces an electrical signal that represents the intensity of the X-ray beam at the position of the element during the time the beam strikes the detector. The gantry 52 is rotated around the subject of interest in a direction 58 so that a plurality of radiographic views may be collected by the computer 36 (see FIG. 1). Furthermore, in accordance with exemplary aspects of the present technique, the detector array 22 may include a plurality of energy integrating detector elements 60 and a plurality of energy discriminating detector elements 62 arranged in a spatial relationship. The exemplary arrangements of the energy integrating detector elements 60 and the energy discriminating detector elements 62 will be described in greater detail hereinafter.

Thus, as the X-ray source 12 and the detector 22 rotate, the detector 22 collects data related to attenuated X-ray beams 66. Data collected from the detector 22 then undergoes pre-processing and calibration to condition the data to represent the line integrals of the attenuation coefficients of the scanned objects. The processed data, commonly called projections, may then be filtered and backprojected to generate an image of the scanned area. An image may be reconstructed, in certain modes, using projection data for less or more than 360 degrees of rotation of the gantry 52.

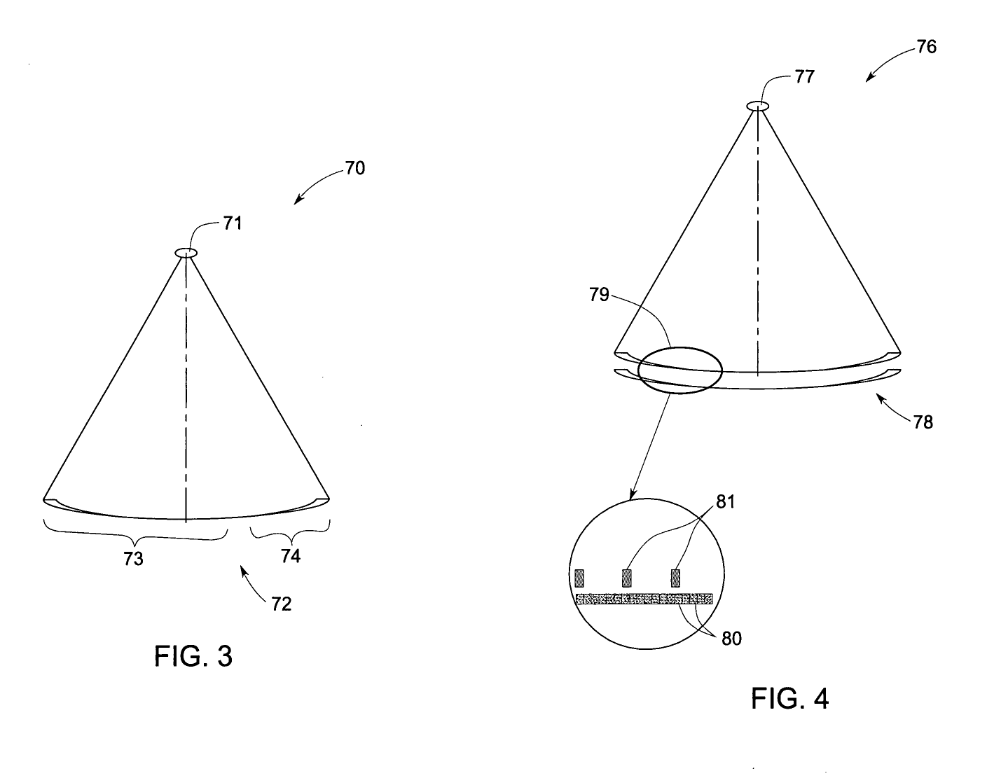

In accordance with aspects of the present technique, various exemplary embodiments of a hybrid detector are presented. As used herein, a “hybrid” detector is a detector that includes a plurality of energy integrating detector elements and a plurality of energy discriminating detector elements arranged in a predetermined pattern. Also, the hybrid detector may include a planar detector, a ring-shaped detector, an arc-shaped detector, or combinations thereof. The various shapes of the hybrid detector, and the numerous arrangements of the energy integrating and energy discriminating detector elements will be described in greater detail with reference to FIGS. 3-22.

Turning now to FIG. 3, an exemplary embodiment 70 of a detector arc for use in the imaging system of FIGS. 1-2 is illustrated. Reference numeral 71 represents a source of radiation, such as the source 12 (see FIG. 1). However, more than one source of radiation may be employed as will be described hereinafter. Furthermore, a non-symmetric detector arc 72 may include a plurality of energy discriminating detector elements 73 and a plurality of energy integrating detector elements 74. It may be noted that in certain embodiments each of the plurality of energy integrating detector elements 73 and each of the plurality of energy discriminating detector elements 74 may be representative of individual detector pixels. However, in certain other embodiments, each of the plurality of energy integrating detector elements 73 and each of the plurality of energy discriminating detector elements 74 may be representative of separate detectors. In certain embodiments, the energy integrating detector elements may be physically separated from the energy discriminating detector elements. However, the detector may be configured to include the set of all detector elements in the CT scanner. As will be appreciated, the energy discriminating detector elements 73 may be configured to provide energy discrimination data but with a relatively low dynamic range in photon flux rate, while the energy integrating detector elements 74 may be configured to provide energy integration data with a wide dynamic range in photon flux rate. In a presently contemplated configuration, the detector arc 72 may include the plurality of energy discriminating detector elements 73 disposed on a first side of the detector arc 72, while the plurality of energy integrating detector elements 74 may be disposed on a second side of the detector arc 72, where the second side is opposingly disposed with respect to the first side of the detector arc 72. In certain embodiments, the detector arc 72 may be asymmetric, as shown in FIG. 3.

By implementing the detector arc 72 as described hereinabove, patient scan data acquired at zero degrees may be rescanned at 180 degrees incorporating full 360 degrees scanning and fan-to-parallel rebinning. However, as the tube and the detector assembly are rotated around the patient, the energy integrating detector elements 74 and the energy discriminating detector elements 73 swap sides relative to the patient. Using this opposing view geometry of the detector arc 72, energy integrating data may always be available to correct for possible saturated data from the energy discriminating detector elements 73 in every view of the scan. As will be appreciated, in cone-beam geometries of the detectors, direct rays and conjugate rays may be located at different positions. It may be noted that the arrangement of the energy integrating detector elements and energy discriminating detector elements described hereinabove may also be adapted for use in the cone-beam geometries.

FIG. 4 illustrates another embodiment 76 of a detector arc 78. Reference numeral 77 is representative of a source of radiation. In one embodiment, the detector arc 78 may include an arrangement of a plurality of energy discriminating detector elements alternatingly interspersed with a plurality of energy integrating detector elements. This arrangement advantageously facilitates employing the energy integrating detector elements to correct possible saturation defects in neighboring energy discriminating detector elements.

Alternatively, a select part of the detector arc 78 may be configured to include a plurality of energy discriminating detector elements and a plurality of energy integrating detector elements arranged in a “comb like” pattern. In certain embodiments, every N^{th} energy discriminating detector element may be replaced with an energy integrating detector element. For example, in one embodiment, the detector arc 78 may include a plurality of energy discriminating detector elements disposed in a row, where every 5^{th} energy discriminating detector element is replaced with an energy integrating detector element (not shown). Furthermore, in certain other embodiments, every N^{th} energy discriminating detector element may be “shielded” by an energy integrating detector element, as illustrated in FIG. 4. For example, in one embodiment, the detector arc 78 may include a plurality of energy discriminating detector elements 80 disposed in a row, where every 5^{th} energy discriminating detector element is “shielded” by an energy integrating detector element 81 as illustrated in an enlarged view of a portion 79 of the detector arc 78. In other words, a sparse distribution of energy integrating detector elements 81 arranged in an array may be mounted on the row of energy discriminating detector elements 80.

By implementing the detector arc 78 as described hereinabove, measurements detected from the sparsely distributed energy integrating detector elements 81 may be utilized to correct measurements obtained from the neighboring saturated energy discriminating detector elements 80. Additionally, self-absorption of these energy integrating detector elements 81 facilitates reduction in flux to the underlying energy discriminating detector elements 80 thereby ensuring that the energy discriminating detector elements 80 are substantially precluded from reaching saturation. These “shielded” measurements from the energy discriminating detector elements 80 provide a more precise correction for their neighboring “unshielded” energy discriminating detector elements 80.

It may be noted that, in certain embodiments, the roles of the energy integrating detector elements 81 and the energy discriminating detector elements 80 may be reversed depending on the size of the features to be evaluated in the object. In other words, the energy discriminating detector elements 80 may be disposed on the top while the energy integrating detector elements 81 may be disposed below the energy discriminating detector elements 80. Furthermore, detector parameters, such as thickness of direct conversion material, may be adjusted in the energy discriminating detector elements 80 to facilitate prevention of saturation of the energy discriminating detector elements 80.

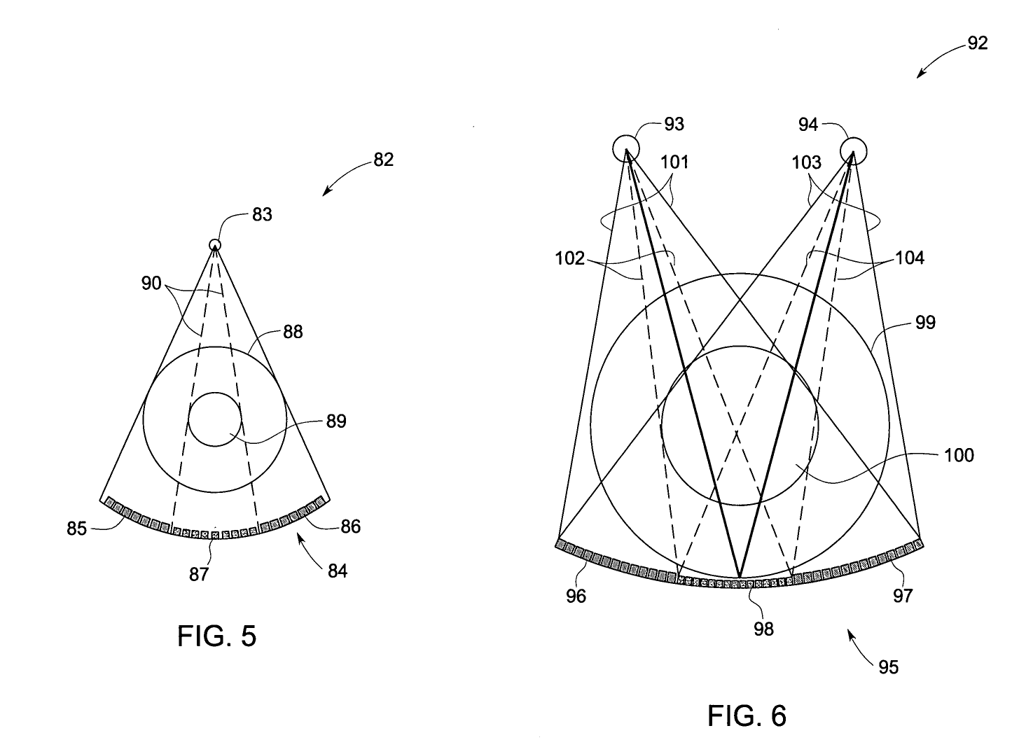

Referring now to FIG. 5, an exemplary embodiment 82 of a detector arc 84 is illustrated. Also, reference numeral 83 represents a source of radiation. The detector arc 84 may include a first side wing 85, a second side wing 86 and a center portion 87 disposed between the first and second side wings 85, 86. In a presently contemplated configuration, the first side wing 85 may include a first set of a plurality of energy integrating detector elements. In a similar fashion, the second wing 86 may include a second set of a plurality of energy integrating detector elements. Furthermore, the center portion 87 may include a plurality of energy discriminating detector elements. Reference numeral 88 is representative of a relatively large region of interest, while reference numeral 89 is representative of a relatively small region of interest. In addition, a portion of the X-ray beam which may be configured to illuminate the center portion 87 of the detector 84 is represented by reference numeral 90. The X-ray beam may be configured to illuminate the full detector 84 including the first side wing 85 and the second side wing 86. By implementing the detector arc 84 as described hereinabove, a center portion of the region of interest, such as a relatively smaller region of interest 89 may be reconstructed with energy information, where as a relatively larger region of interest 88 may be used to support the reconstruction by providing attenuation information outside the relatively smaller region of interest 89.

FIG. 6 illustrates another exemplary embodiment 92 of a combined detector arc 95. In this embodiment, a first source of radiation 93 and a second source of radiation 94 may be employed. It may be noted that the first source of radiation 93 and the second source of radiation 94 may be illuminated sequentially, in one embodiment. Furthermore, in accordance with aspects of the present technique, more than two sources of radiation may also be employed. In another embodiment, the sources 93 and 94 may consist of multiple X-ray emission points distributed longitudinally. The detector arc 95 may include a first side wing 96, a second side wing 97 and a center portion 98 disposed between the first and second side wings 96, 97. In a presently contemplated configuration, the first side wing 96 may include a first set of a plurality of energy integrating detector elements. In a similar fashion, the second side wing 97 may include a second set of a plurality of energy integrating detector elements. Furthermore, the center portion 98 may include a plurality of energy discriminating detector elements. Reference numeral 99 is representative of a relatively large region of interest, while reference numeral 100 is representative of a relatively small region of interest.

In accordance with exemplary aspects of the present technique, two outer portions of the X-ray beam may be measured by the plurality of energy integrating detector elements, while a central portion of the X-ray beam may be measured by the plurality of energy discriminating detector elements. Accordingly, as depicted in the illustrated embodiment 92, the two outer portions of the X-ray beam 101 generated by the first source of radiation 93 may be measured by the plurality of energy integrating detector elements in the first and second side wings 96, 97. Moreover, the central portion of the X-ray beam 102 generated by the first source of radiation 93 may be measured by the plurality of energy discriminating detector elements in the central portion 98 of the detector arc 95.

Similarly, the two outer portions of the X-ray beam 103 generated by the second source of radiation 94 may be measured by the plurality of energy integrating detector elements in the first and second side wings 96, 97. Furthermore, the central portion of the X-ray beam 104 generated by the second source of radiation 94 may be measured by the plurality of energy discriminating detector elements in the central portion 98 of the detector arc 95.

By implementing the detector arc 95 as described hereinabove, a center portion of the region of interest, such as a relatively smaller region of interest 100, may be reconstructed with energy information, where as a relatively larger region of interest 99 may be used to support the reconstruction by providing attenuation information outside the relatively smaller region of interest 100. In other words, sufficient data is available to reconstruct the relatively larger region of interest 99 without energy information. Additionally, sufficient data is available to reconstruct the relatively smaller region of interest 100 with energy information.

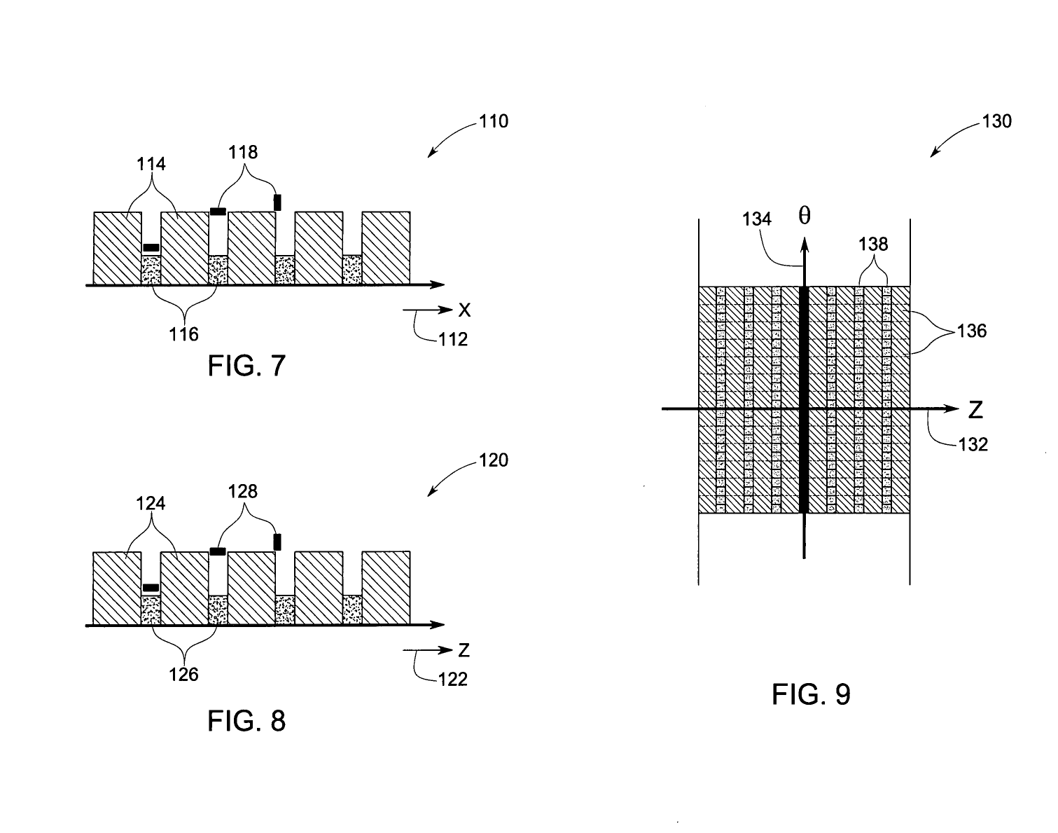

FIGS. 7-8 illustrate exemplary arrangements of a plurality of energy integrating detector elements and energy discriminating detector elements in a detector module. Turning now to FIG. 7, an exemplary arrangement 110 where a plurality of energy discriminating detector elements 116 is alternatingly disposed between a plurality of energy integrating detector elements 114 in a X-direction 112 is illustrated. In addition, the arrangement 110 may also include a plurality of pre-attenuators 118, where the pre-attenuators may be configured to attenuate the flux to the energy discriminating detector elements 116 in cases where relatively high flux illumination of the detector elements is anticipated by the system, such as the system 10 illustrated in FIG. 1, for example. It may be noted that, in accordance with aspects of the present technique, the plurality of pre-attenuators 118 may be configured to be in a first position or a second position. The first position may include a horizontal position, while the second position may include a vertical position, for example. In certain embodiments, the pre-attenuators 118 may include a plurality of movable collimator blades configured to rotate into a horizontal position so as to attenuate the flux when the system has determined that portion of the detector is to receive relatively high flux rate illumination. Such a condition of relatively high flux illumination may occur, for example, outside the projected edge of an object where the air-only attenuated flux from the source is incident directly on the detector. Such a condition is more likely at the edges of the detector and may be anticipated with knowledge of the system geometry and patient size and shape. Additionally, in a condition of relatively lower flux illumination, the collimator blades may be adapted to rotate to a vertical position. The collimator blades in the vertical position may be employed to facilitate reduction in scattered radiation.

As illustrated in FIG. 7, in certain embodiments, each of the plurality of energy discriminating detector elements 116 may be relatively smaller than each of the plurality of energy integrating detector elements 114. For example, each of the plurality of energy integrating detector elements 114 may be sized in a range from about 1 mm to about 5 mm while each of the plurality of energy discriminating detector elements 116 may be sized in a range from about 0.2 mm to about 1.0 mm. Consequent to the relatively smaller size, each of the plurality of energy discriminating detector elements 116 experiences a corresponding lower count rate, thereby advantageously circumventing saturation problems associated with detector elements having a larger size. The exemplary arrangement 110 illustrated in FIG. 7 presents a “balanced” design choice of the relatively large energy integrating detector elements 114 and the relatively small energy discriminating detector elements 116.

FIG. 8 illustrates an alternate arrangement 120 of a plurality of energy integrating detector elements 124 and a plurality of energy discriminating detector elements 126 arranged in a Z-direction 122. As previously noted with reference to FIG. 7, the exemplary arrangement 120 may also include a plurality of attenuators, such as movable collimator blades 128.

It may be noted the detector modules illustrated in FIGS. 7-8 may include a one-dimensional array or a two dimensional array of energy integrating detector elements. Additionally, a plurality of energy discriminating detector elements may be disposed in between or at the side of the energy integrating detector elements. This interleaving may include a row-by-row interleaving, a column-by-column interleaving, or a checkerboard pattern. Furthermore, as previously noted, the energy discriminating detector elements may be relatively smaller sized compared to the energy integrating detector elements to facilitate reduction in the X-ray count-rate. The detector module may also include the pre-attenuators, which may include one or more collimator blades, in certain embodiments. In this case the attenuators may be rotated from a vertical to a horizontal position to convert the function from collimator blade to an attenuator.

Optionally, some of the detector elements, such as the energy discriminating detector elements may also be offset in height. This arrangement greatly facilitates reduction in sensitivity of the detector elements to scatter as the detector elements positioned a little deeper are less sensitive to scatter. Additionally, regions in the scintillator of the energy integrating detector elements may be selectively configured to be less absorptive by reducing scintillator thickness or by reducing material doping, thereby allowing flexibility in positioning of the energy discriminating detector elements behind the energy integrating detector elements. Moreover, behind the less absorptive regions of the scintillator in the energy integrating detector elements, collimating plates may be employed to reduce residual scatter in measurements from the energy discriminating detector elements, thereby enabling improved material composition estimates.

Referring now to FIG. 9, an exemplary arrangement 130 of a plurality of energy integrating detector elements 136 and a plurality of energy discriminating detector elements 138 arranged in a Z-direction 132. It may be noted that, in certain other embodiments, the plurality of energy integrating detector elements 136 and a plurality of energy discriminating detector elements 138 may be arranged in the Z-direction 132 and a O-direction 134 in a checkerboard pattern (not shown). As previously noted with reference to FIG. 7, each of the plurality of energy discriminating detector elements 138 are sized to be relatively smaller compared to the plurality of energy integrating detector elements 136. Consequently, the energy discriminating detector elements 138 may be advantageously configured to handle a relatively low X-ray count rate due to their relatively smaller size, thereby circumventing over-ranging of the energy discriminating detector elements 138. Furthermore, due to the relatively smaller size of the energy discriminating detector elements 138 scatter may be reduced.

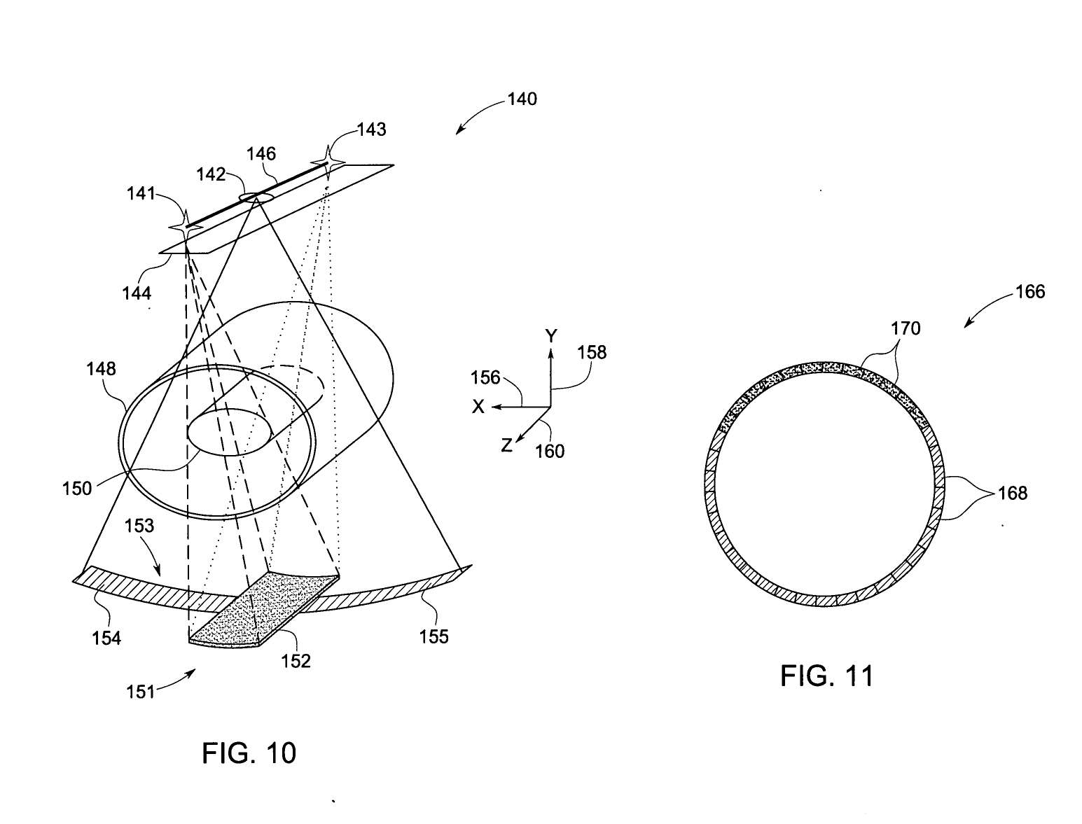

FIG. 10 illustrates an exemplary arrangement 140 where a plurality of energy integrating detector elements and a plurality of energy discriminating detector elements are arranged in a “cross-shaped” configuration of a detector 151. As used herein, a “cross-shaped” configuration refers generally to a detector and corresponding source illumination that has wider coverage at the center of the field of view than at the edge. In a presently contemplated configuration, the cross-shaped detector 151 is shown as including an area detector 152 and a fan detector 153. The area detector 152 may be representative of a central portion of the cross-shaped detector 151. In addition, the fan detector 153 may include a first wing 154 and a second wing 155. Additionally, the area detector 152 may have a first width and the fan detector 153 may have a second width, where the first width is different from the second width.

Furthermore, the area detector 152 may be constructed employing high resolution and/or energy discriminating detector elements, whereas the fan detector 153 may be constructed using low resolution and/or energy integrating detector elements. Accordingly, the cross-shaped configuration is an arrangement whereby a region of an object at the center of the field of view is projected to a wide detector coverage detector, whereas the peripheral region of the object is projected to a narrow coverage. Such an arrangement allows leveraging the fact that the object attenuation is greatest in the center. As a result, the energy discriminating detector elements in the area detector 152 will not be saturated. In addition, a central portion of the detector, such as the area detector 152, has a larger coverage of the object. Accordingly, this larger coverage may be leveraged for cardiac imaging. In conventional geometries, cardiac imaging requires a strongly reduced table speed. However, if the central portion of the detector, such as the area detector 152, which corresponds to the heart region, is wider, the table speed may be increased again.

In addition, this exemplary arrangement 140 may also include a first outer source 141, a second outer source 143 and a central source 142. The sources of radiation 141, 142, 143 may be configured to separately illuminate the area detector 152 and the fan detector 153 or the fan detector 153 and a central portion of the area detector 152. The central source 142 may be configured to illuminate the area detector 152 and the fan detector 153, or a central portion of the area detector 152 and the fan detector 153. Also, the additional sources 141 and 143 may be configured to illuminate only the area detector 152. For example, the additional sources 141 and 143 allow may be configured to facilitate reduced cone-beam artifacts in the relatively small region of interest 150, particularly in axial acquisition modes.

A source collimator is represented by reference numeral 144, while a source gating and collimating control is represented by reference numeral 146. As illustrated in FIG. 10, a relatively large region of interest of the object is represented by reference numeral 148 and reference numeral 150 is representative of a relatively small region of interest. Moreover, a X-direction and a Y-direction are represented by reference numerals 156 and 158 respectively.

Turning now to FIG. 11, a perspective view 166 of an exemplary arrangement of detector elements for use in a stationary computed tomography (sCT) system is illustrated. As will be appreciated, a stationary CT system includes one or more stationary sources of radiation (not shown). In the illustrated embodiment, the detector 166 is shown as including a ring-shaped detector that may be disposed about one or more X-ray sources in a stationary CT system. It may be noted that the ring-shaped detector 166 is stationary relative to the gantry of the stationary CT imaging system. In the embodiment illustrated in FIG. 11, the detector 166 is shown as including one ring. A plurality of energy integrating detector elements 168 may be arranged along a first portion of the ring-shaped detector 166. Furthermore, a plurality of energy discriminating detector elements 170 may also be arranged adjacent to the plurality of energy integrating detector elements 168 and along a second portion of the ring-shaped detector 166.

It may be noted that, it is also contemplated that the detector 166 may include one or more rings. In one embodiment, a plurality of energy integrating detector elements 168 may be disposed on a first ring-shaped detector, while a plurality of energy discriminating detector elements 170 may be disposed on a second ring-shaped detector. The detector 166 may also include alternating rings of energy integrating detector elements and energy discriminating detector elements. Additionally, a plurality of energy integrating detector elements 168 and a plurality of energy discriminating detector elements 170 may be arranged on the one or more ring-shaped detectors in a checkerboard pattern. Moreover, the energy integrating detector elements 168 and energy discriminating detector elements 170 may be arranged in a plurality of configurations on the one or more ring-shaped detectors. For example, the energy integrating detector elements 168 and energy discriminating detector elements 170 may be disposed on the one or more ring-shaped detectors arranged based on the numerous arrangements of energy integrating detector elements and energy discriminating detector elements illustrated in FIGS. 7-9.

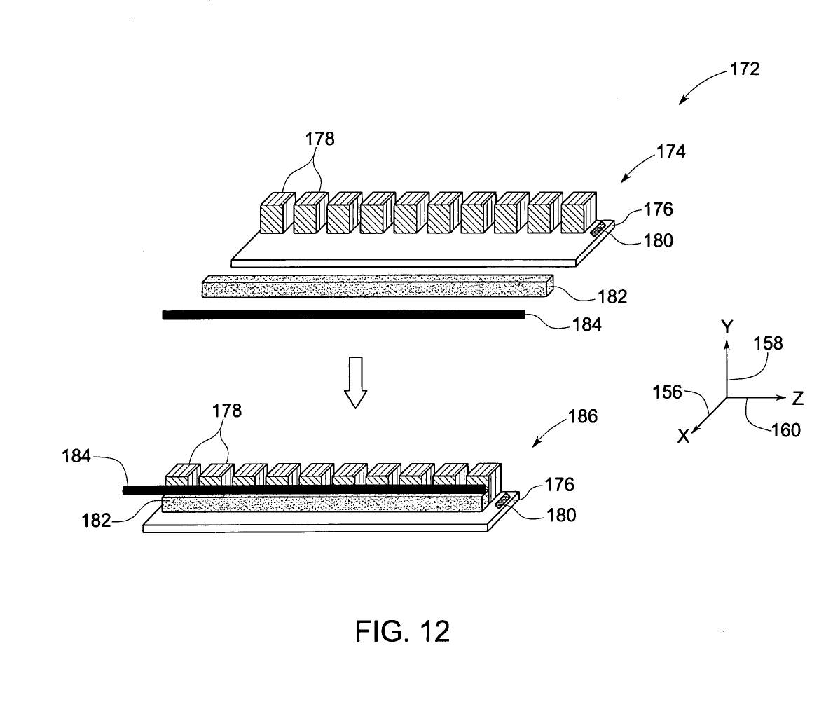

FIG. 12 may be employed as a schematic 172 illustrating formation of an assembly for use in a detector module. An exploded view 174 of the assembly is illustrated. In the illustrated embodiment, a plurality of energy integrating detector elements 178 may be disposed on a first substrate 176. In certain embodiments, the plurality of energy integrating detector elements 178 disposed on the substrate 176 may include a scintillator array with reflector matrix interspersed between scintillator crystals. Furthermore, the first substrate 176 may include a front-lit diode strip. Additionally, a wire bond 180 may also be disposed on the substrate 176, where the wire bond 180 may be configured to facilitate operatively coupling the plurality of energy integrating detector elements 178 to associated electronics, for example. Furthermore, the assembly 174 may also include a plurality of energy discriminating detector elements 182 disposed adjacent the plurality of energy integrating detector elements 178. In one embodiment, the plurality of energy discriminating detector elements 182 may include a direct conversion photon-counting sensor. The assembly 174 may also include a rotatable filtering element 184. The filtering element 184 may be configured to block one or more energy discriminating detector elements 182. Also, in certain embodiments, the filtering element 184 may include a movable filter. Reference numeral 186 is representative of a formed assembly.

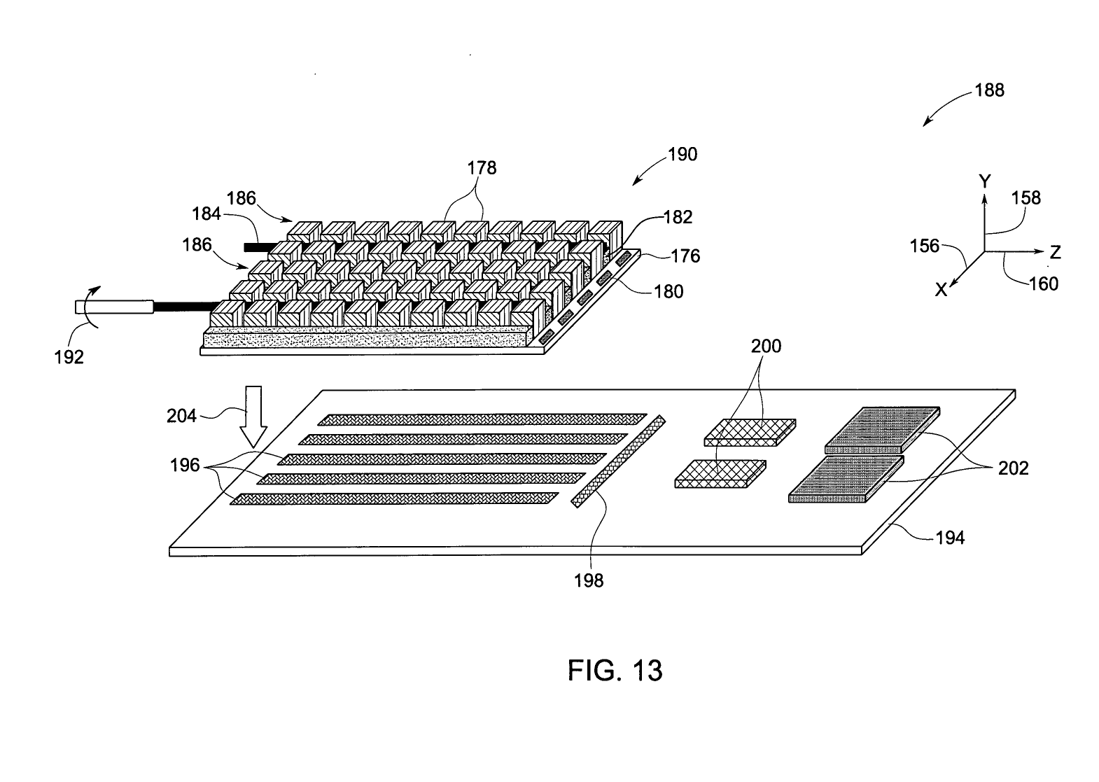

FIG. 13 may be employed as a schematic illustrating formation of a detector module. An exploded view 188 of the detector module is illustrated. In a presently contemplated configuration, the detector assembly 188 is shown as including a detector assembly 190. According to aspects of the present technique, the detector module 190 may include a plurality of assemblies 186 (see FIG. 12) disposed adjacent to one another. As previously noted, the assembly 186 may include a plurality of energy integrating detector elements 178 arranged on a substrate 176, a plurality of energy discriminating detector elements 182 disposed adjacent the plurality of energy integrating detector elements 178 and a filtering element 184 disposed adjacent the plurality of energy discriminating detector elements 182. Also, reference numeral 192 is representative of a direction of rotation of the filtering element 184.

The detector module 188 may also include an interconnection substrate 194. The interconnection substrate 194 may include readout electronics and may be configured to facilitate coupling the plurality of energy integrating detector elements 178 and the plurality of energy discriminating detector elements 182 to associated readout electronics. It may be noted that the readout electronics may be configured to facilitate reading out signals from each of the plurality of energy integrating detector elements 178 and each of the plurality of energy discriminating detector elements 182. In certain embodiments, the interconnection substrate 194 may include a printed circuit board (PCB) or a ceramic electrical wiring board substrate, for example. Furthermore, in certain embodiments, the interconnection substrate 194 may include electronics disposed thereon, where the electronics may be configured to transmit and receiver data and/or power to the detector module 190.

Furthermore, the interconnection substrate 194 may include one or more interconnect pads 196 that may be configured to facilitate coupling the plurality of energy discriminating detector elements 182 to respective readout electronics. In certain embodiments, the interconnection substrate 194 may include a plurality of strips of interconnect pads to facilitate coupling a plurality of back-connected energy discriminating detector elements 182 to associated readout electronics. However, in certain other embodiments, the interconnection substrate 194 may include a full array of interconnect pads configured to facilitate coupling the plurality of back-connected energy discriminating detector elements 182 to respective readout electronics.

Moreover, the interconnection substrate 194 may also include wire bond pads 198. The plurality of energy integrating detector elements 178 may be coupled to the interconnection substrate 194 by operatively coupling the wire bonds 180 to the wire bond pads 198. It may be noted that use of backlit diodes does not call for use of wire bond pads 198. However, the wire bond pads 198 may be included for front-lit diodes employed in the substrate 176. Additionally, reference numeral 200 is representative of readout electronics associated with the plurality of energy integrating detector elements 178. Similarly, reference numeral 202 represents readout electronics associated with the plurality of energy discriminating detector elements 182. In certain embodiments, the readout electronics 200 and 202 may include application specific integrated circuits (ASICs). Furthermore, reference numeral 204 is representative of a direction of operatively coupling the detector assembly 190 to the interconnection substrate 194. In one embodiment, the detector assembly 190 may be electrically bonded to the interconnection substrate 194.

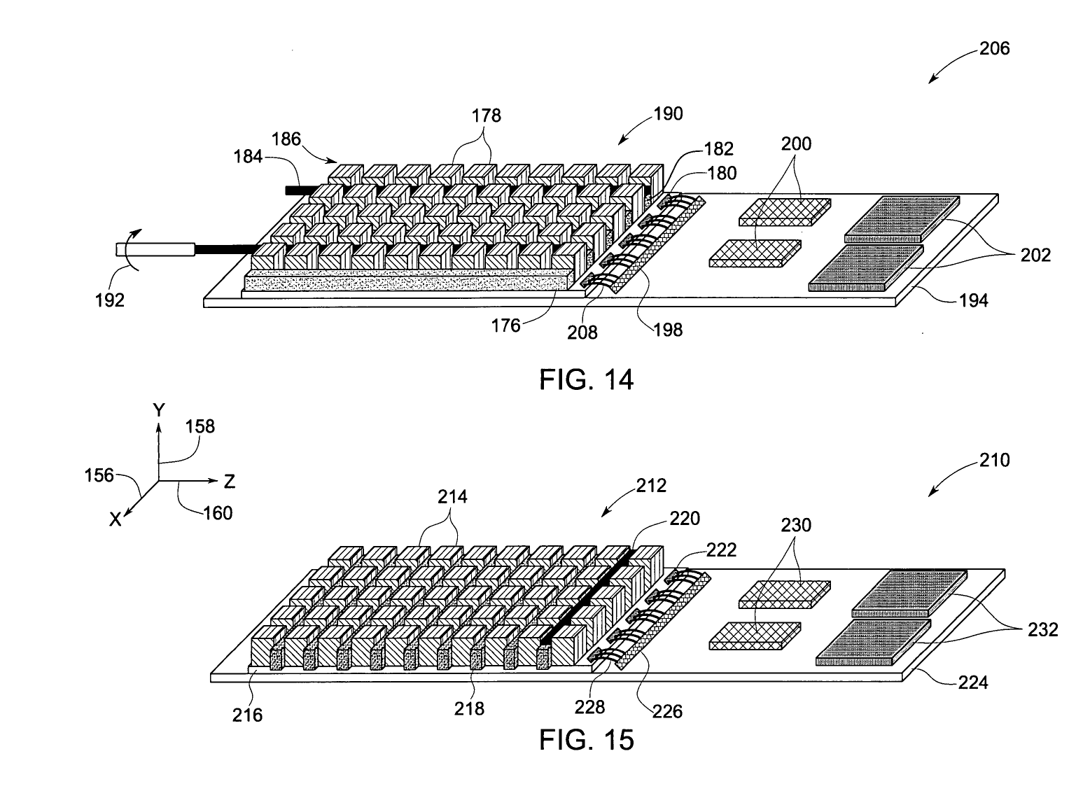

Turning now to FIG. 14, an embodiment 206 of a fully assembled detector module is illustrated. Also, the wire bond pads 180 disposed on the substrate 176 are shown as being operatively coupled to the wire bond pads 198 disposed on the interconnection substrate 194 via wires 208. It may be noted that in the illustrated embodiment, the plurality of energy discriminating detector elements 182 is disposed along the Z-direction 160.

FIG. 15 illustrates an alternate embodiment 210 of a detector module where a plurality of energy discriminating detector elements 218 is disposed along the X-direction 156. The detector module 210 may include an assembly 212, as previously noted with reference to FIG. 14. The assembly 212 may include a plurality of energy integrating detector elements 214 disposed on a substrate 216. In addition, the substrate 216 may also include wire bonds 222. In certain embodiments, the plurality of energy discriminating detector elements 218 may be disposed adjacent the plurality of energy integrating detector elements 214. Furthermore, a filtering element 220 may be disposed adjacent the plurality of energy discriminating detector elements 218. It may be noted that although FIG. 15 is illustrated as including one filtering element 220, the detector module 210 may include one or more filtering elements. In a presently contemplated configuration, the filtering element 220 may include a non-movable filtering element. The assembly 212 may then be disposed on a interconnection substrate 224 having a plurality of interconnect pads (not shown) and a plurality of wire bond pads 226. The wire bonds 222 may be coupled to the wire bond pads 226 via wires 228. Moreover, the interconnection substrate 224 may also include one or more energy integrating ASICs 230 and one or more energy discriminating ASICs 232.

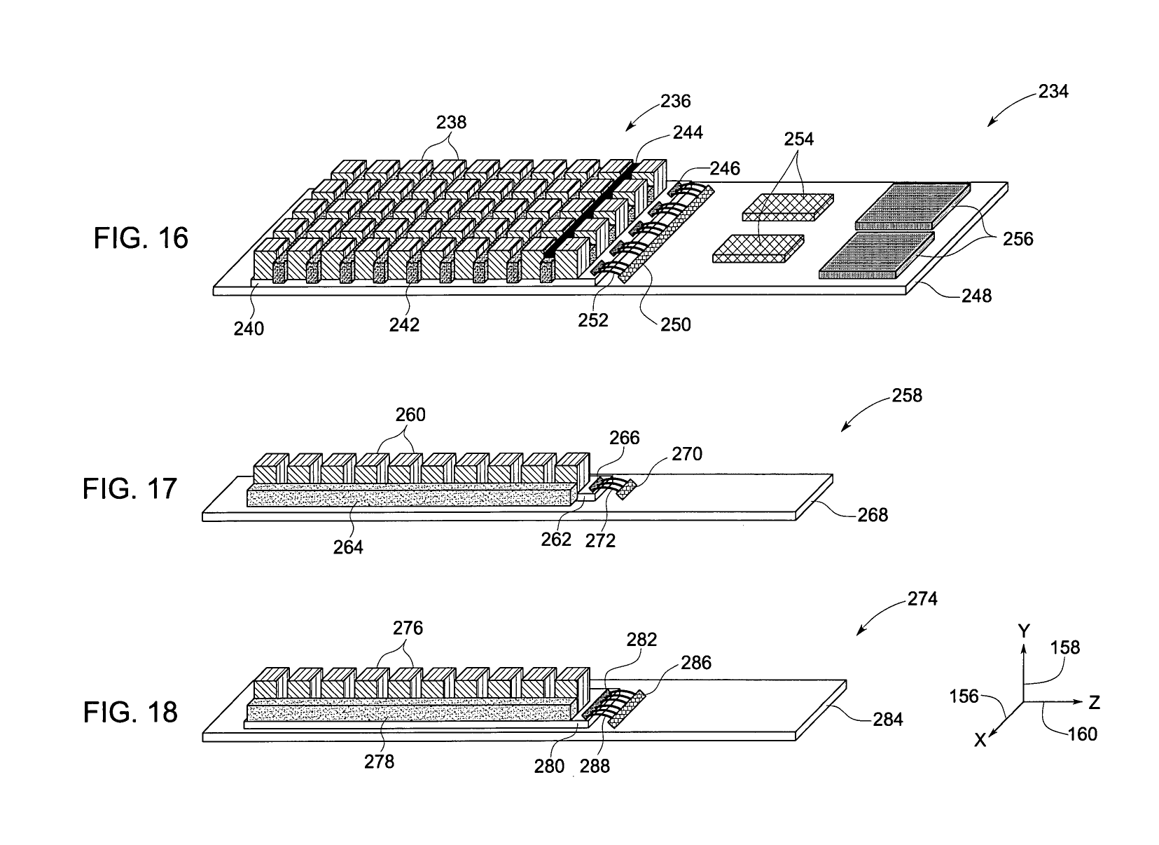

Referring now to FIG. 16, yet another embodiment 234 of a detector module is illustrated. The detector module 234 may include an assembly 236 having a plurality of energy integrating detector elements 238 disposed on a substrate 240. The substrate 240 may also include a plurality of wire bonds 246. In the illustrated embodiment, the assembly 236 is shown as including a plurality of energy discriminating detector elements 242 disposed adjacent the plurality of energy integrating detector elements 238 and arranged along the X-direction 156 and the Z-direction 160. In addition, the assembly 236 may also include a filtering element 244 disposed adjacent the plurality of energy discriminating detector elements 242. It may be noted that although FIG. 16 is illustrated as including one filtering element 244, the detector module 234 may include one or more filtering elements. The detector module 234 may also include an interconnection substrate 248 having a plurality of interconnect pads (not shown) and a plurality of wire bond pads 250. The wire bonds 246 on the substrate 240 may be operatively coupled to the wire bond pads 250 via wires 252. Additionally, one or more energy integrating ASICs 254 and one or more energy discriminating ASICs 256 may be disposed on the interconnection substrate 248.

FIGS. 17-18 illustrate interlacing of energy integrating detector elements and energy discriminating detector elements with wire bond interconnect. FIG. 17 illustrates a perspective view 258 of an embodiment of a detector module where a plurality of energy integrating detector elements 260 and a plurality of energy discriminating detector elements 264 are separately bonded to an interconnection substrate 268. The plurality of energy integrating detector elements 260 is shown as being disposed on a substrate 262. As previously noted, the substrate 262 may include a wire bond 266, while the interconnection substrate 268 may include a wire bond pad 270. The wire bond 266 disposed on the substrate 262 may be operatively coupled to the wire bond pad 270 on the interconnection substrate 268 via wires 272. In other words, the plurality of energy integrating detector elements 260 may be operatively coupled to the interconnection substrate 268 via the first substrate 262, while the plurality of energy discriminating detector elements 264 may be directly coupled to the interconnection substrate 268.

Turning now to FIG. 18, a perspective view 274 of an embodiment of a detector module where a plurality of energy integrating detector elements 276 and a plurality of energy discriminating detector elements 278 are bonded to a substrate 280 which in turn is bonded to an interconnection substrate 284 is illustrated. In the illustrated embodiment, the plurality of energy integrating detector elements 276 and the plurality of energy discriminating detector elements 278 are shown as being disposed on the substrate 280. The substrate 280 may include an interposer, in certain embodiments. The substrate 280 may include a wire bond 282, while the interconnection substrate 284 may include a wire bond pad 286. The plurality of energy integrating detector elements 276 and the plurality of energy discriminating detector elements 278 may be operatively coupled to the substrate 280. The substrate 280 is then operatively coupled to the interconnection substrate 284 via wires 288, which may be configured to couple the wire bond 282 on the substrate 280 to the wire bond pad 286 on the interconnection substrate 284. In other words, the plurality of energy integrating detector elements 276 and the plurality of energy discriminating detector elements 278 may be coupled to the interconnection substrate 284 via the substrate 280, as illustrated in FIG. 18.

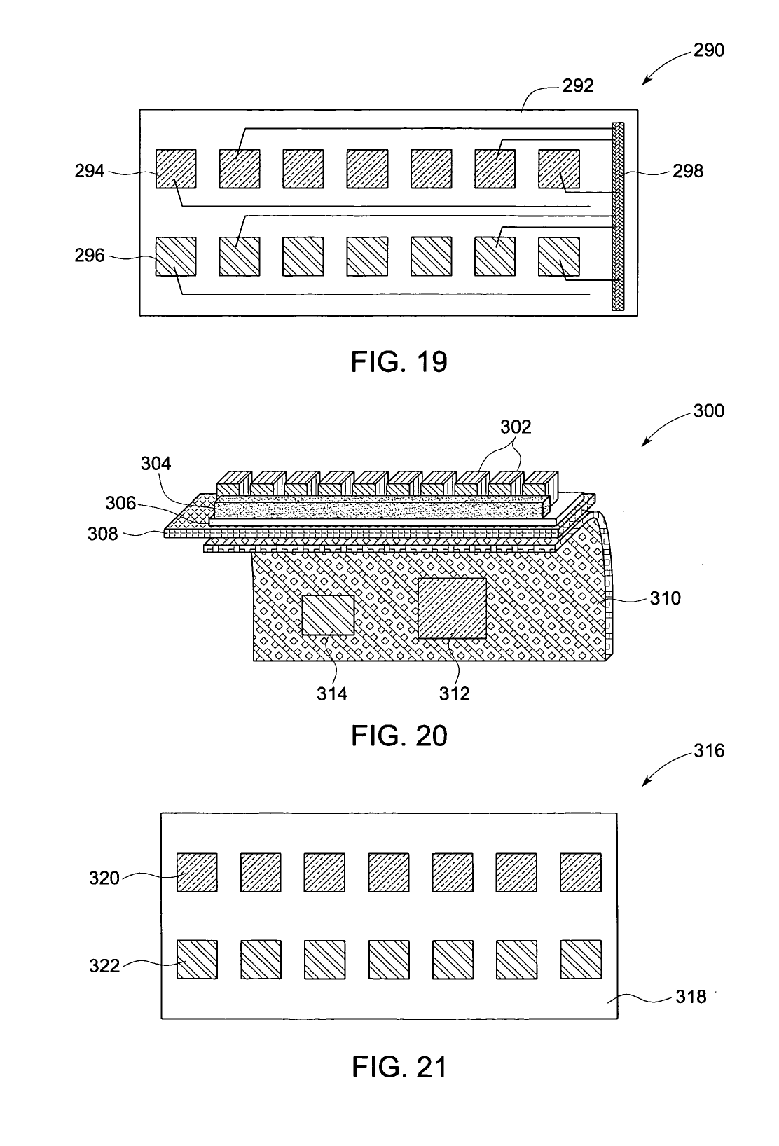

As previously noted with reference to FIG. 18, in certain embodiments, the substrate 280 may include an interposer. FIG. 19 illustrates a top view 290 of the interposer 280 (see FIG. 18). The interposer 280 may include a substrate 292. Further, a plurality of front-lit diode pads 294 may be patterned on the substrate 292. Additionally, a plurality of metal interconnect pads 296 may be patterned on the substrate 292. Reference numeral 298 is representative of wire bonds. The plurality of energy integrating detector elements, such as the energy integrating detector elements 276 (see FIG. 18), may be coupled to the front-lit diode pads 294, while the plurality of energy discriminating detector elements, such as the energy discriminating detector elements 278 (see FIG. 18), may be coupled to the metal interconnect pads 296.

Turning now to FIG. 20, a perspective view 300 of an exemplary embodiment of a detector module is illustrated. Additionally, FIG. 20 illustrates an embodiment where a plurality of energy integrating detector elements 302 and a plurality of energy discriminating detector elements 304 are operatively coupled to corresponding readout electronics 312, 314 by employing through-via interconnects. The plurality of energy integrating detector elements 302 and the plurality of energy discriminating detector elements 304 may be disposed on a substrate 306. In certain embodiments, the substrate 306 may include a silicon through-via interposer layer. The interposer layer may contain interconnect wiring, vias and active photodiode devices so as to route sensor element signals to readout electronics. The detector module 300 may also include an interconnection substrate 308. In one embodiment, the interconnection substrate 308 may include a PCB or a ceramic substrate, as previously described. In addition, the detector module 300 may include a flexible circuit 310 having one or more energy integrating ASICs 312 and one or more energy discriminating ASICs 314 disposed thereon.

An assembly including the plurality of energy integrating detector elements 302, the plurality of energy discriminating detector elements 304 and the substrate 306 including the through-via interposer therein may be disposed on a first side of the interconnection substrate 308. Also, the flex circuit 310 having the energy integrating ASICs 312 and the energy discriminating ASICs 314 may be disposed on a second side of the interconnection substrate 308, where the second side is opposingly disposed from the first side of the interconnection substrate 308. The plurality of energy integrating detector elements 302 and the plurality of energy discriminating detector elements 304 may be operatively coupled to the corresponding readout electronics, such as the energy integrating ASICs 312 and the energy discriminating ASICs 314, via the interposer included with substrate 306.

FIG. 21 illustrates a top view 316 of the through-via interposer included with substrate 306 of FIG. 20. The through-via interposer may include a substrate 318 which may be silicon, PCB or ceramic wiring board. In addition, a plurality of through-via silicon photodiode pads 320 may be fabricated on the substrate 318 corresponding to each of the energy integrating detector elements 302 (see FIG. 20). A plurality of metal interconnect pads 322 may also be patterned on the substrate 318 corresponding to the energy discriminating detector elements 304 (see FIG. 20). In certain embodiments, the plurality of through-via photodiode pads 320 may be employed to facilitate operatively coupling the plurality of energy integrating detector elements, such as energy integrating detector elements 302, to corresponding readout electronics, such as energy integrating ASICs 312 (see FIG. 20). In a similar fashion, the plurality of metal interconnect pads 322 may be configured to facilitate operatively coupling the plurality of energy discriminating detector elements, such as energy discriminating detector elements 304, to corresponding readout electronics, such as energy discriminating ASICs 314 (see FIG. 20).

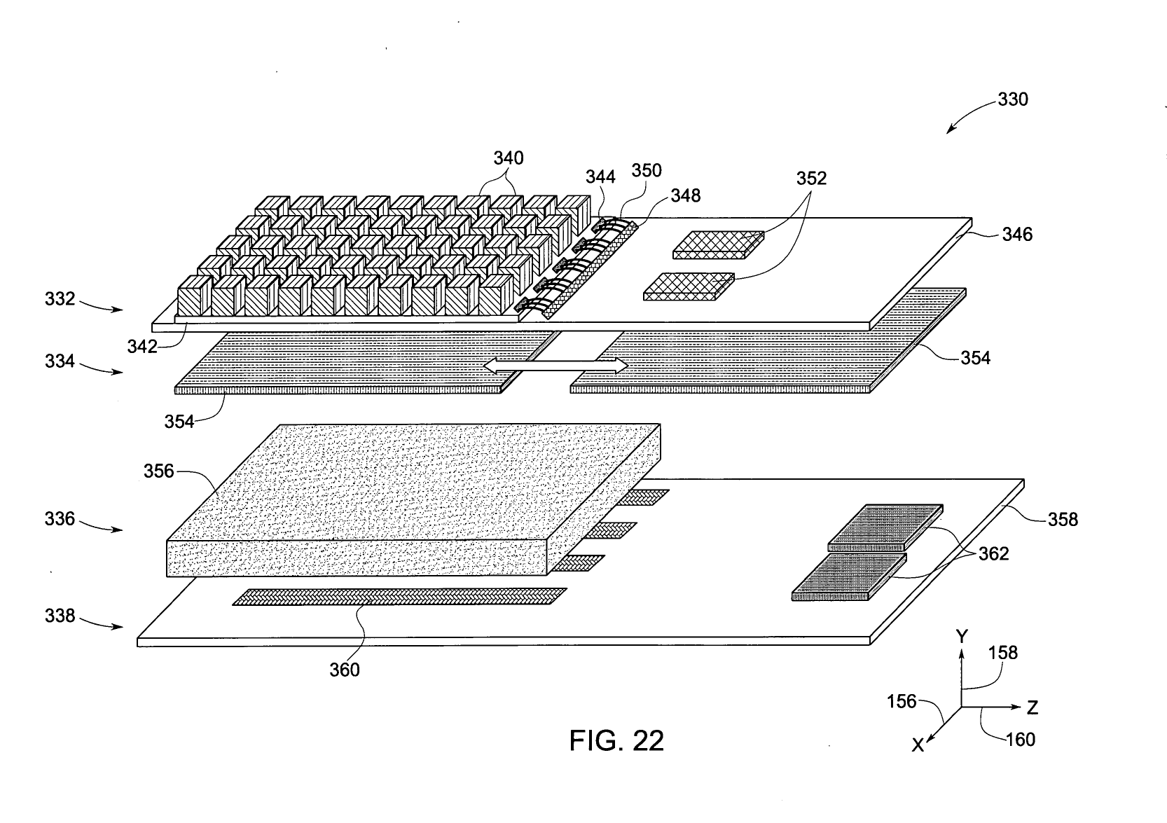

FIG. 22 illustrates an exploded view 330 of a detector module having a layered structure, in accordance with aspects of the present technique. In a presently contemplated configuration, the detector module 330 may include an architecture having a four layered structure. However, as will be appreciated, other architectures are also envisioned in accordance with aspects of the present technique.

The detector module 330 may include a first layer 332, a second layer 334, a third layer 336 and a fourth layer 338. The first layer 332 may include a plurality of energy integrating detector elements 340 arranged with X-ray transparent kerfs between the energy integrating detector elements on a first substrate 342, where the substrate 342 may include one or more wire bonds 344. In certain embodiments, the first substrate may include a scintillator sensor, for example. Additionally, the first layer 332 may also include a first interconnection substrate 346 that may be configured to facilitate coupling the plurality of energy integrating detector elements 340 to corresponding readout electronics. Accordingly, the first interconnection substrate 346 may include one or more wire bond pads 348 disposed thereon. The wire bonds 344 disposed on the substrate 342 may be coupled to the wire bond pads 348 via wires 350. Furthermore, the first interconnection substrate 346 may also include one or more energy integrating ASICs 352 disposed thereon. Also, the plurality of energy integrating detector elements 340 may be operatively coupled to corresponding readout electronics, such as energy integrating ASICs 352, via wires 350.

The second layer 334 may include a filtering element 354. In one embodiment, the filter 354 may be a movable filter, while in other embodiments the filtering element 354 may include a fixed filter. In certain embodiments, the filtering element may be adapted to attenuate relatively low energy X-ray spectra. In addition, the third layer 336 may include a plurality of energy discriminating detector elements 356 which receives the signal transmitted through the kerfs of the first layer 332. It may be noted that the plurality of energy discriminating detector elements 356 may be disposed on a second substrate (not shown). The second substrate may include a ceramic substrate, for example. Moreover, the fourth layer 338 may include a second interconnection substrate 358 configured to facilitate operatively coupling the plurality of energy discriminating detector elements 356 in the third layer 336 to corresponding readout electronics, such as energy discriminating ASICs 362 that may be disposed on the second interconnection substrate 358. The second interconnection substrate 358 may also include one or more interconnect pads 360 that may be configured to facilitate coupling the plurality of energy discriminating detector elements 356 to the second interconnection substrate 358. The plurality of energy discriminating detector elements 356 may be operatively coupled to the energy discriminating ASICs 362 via the second interconnection substrate 360. It may be noted that even though as illustrated in FIG. 22, the plurality of energy integrating detector elements 340 are illustrated as being disposed on top of the energy discriminating detector elements 356, in an alternate embodiment, the plurality of energy discriminating detector elements 356 may be disposed on the top of the plurality of energy integrating detector elements 340, in accordance with aspects of the present technique. In the illustrated embodiment of FIG. 22, the plurality of energy discriminating detector elements 356 is shown as including a continuous layer. However, the plurality of energy discriminating detector elements 356 may be configured to be islands of detector elements disposed on the second substrate, as opposed to the continuous layer. This arrangement of islands of energy discriminating detector elements 356 may advantageously result in relatively lower counts in the energy discriminating detector elements 356, thereby circumventing saturation problems associated with detector elements having a larger size.

The various embodiments of the apparatus for hybrid CT imaging and methods for hybrid CT imaging discussed hereinabove facilitate arranging a plurality of energy integrating detector elements and a plurality of energy discriminating detector elements in a one-dimensional or a two-dimensional detector array. FIGS. 3-6 illustrate exemplary embodiments of an arc-shaped detector. In addition, FIGS. 7-9 and 12-22 illustrate exemplary embodiments of planar detectors. Also, FIG. 10 illustrates a cross-shaped detector, while FIG. 11 illustrates a ring-shaped detector.

Furthermore, the use of energy discriminating detector elements of relatively small size advantageously facilitates reduction in the count rate. Additionally, as the plurality of energy discriminating detector elements are pre-attenuated, reduction in the count rate may be obtained. Also, the flux rate to the energy discriminating detector elements disposed beneath the energy integrating detector elements may be advantageously controlled via selective doping of the scintillator material or selectively controlling the thickness of the scintillator material. Furthermore, collimation of the energy discriminating detector elements cells beneath the energy integrating detector elements facilitates scatter reduction in the measurements obtained from the energy discriminating detector elements, thereby improving material composition estimates.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system comprising:
a plurality of energy integrating detector elements configured to acquire energy integrating data; and
a plurality of energy discriminating detector elements configured to acquire energy discriminating data,
wherein the plurality of energy integrating detector elements and the plurality of energy discriminating detector elements are arranged in a spatial relationship to form a hybrid detector, and wherein the plurality of energy integrating detector elements and the plurality of energy discriminating detector elements are configured to obtain respective sets of energy integrating data and energy discriminating data for use in generating an image.

2. The system of claim 1, wherein each of the plurality of energy integrating detector elements and each of the plurality of energy discriminating detector elements are separate detectors.

3. The system of claim 1, wherein the detector comprises a planar detector, a ring-shaped detector, an arc-shaped detector, or combinations thereof.

4. The system of claim 1, wherein the plurality of energy integrating detector elements and the plurality of energy discriminating detector elements are arranged in a predetermined pattern.

5. The system of claim 4, wherein the plurality of energy discriminating detector elements are alternatingly arranged between the plurality of energy integrating detector elements.

6. The system of claim 4, wherein the plurality of energy integrating detector elements are disposed proximate to the plurality of energy discriminating detector elements.

7. The system of claim 4, wherein the plurality of energy integrating detector elements and the plurality of energy discriminating detector elements are arranged in a cross-shaped configuration.

8. The system of claim 4, wherein a plurality of energy discriminating detector elements is disposed between a first set of energy integrating detector elements and a second set of energy integrating detector elements.

9. The system of claim 4, wherein the detector comprises one or more ring-shaped detectors disposed in a stationary configuration about one or more stationary sources of radiation, and wherein a plurality of energy discriminating detector elements and a plurality of energy integrating detector elements are disposed on the one or more ring-shaped detectors.

10. The system of claim 1, further comprising one or more filtering elements configured to attenuate flux to the plurality of energy discriminating detector elements, wherein the one or more filtering elements are configured to be in a first position or a second position.

11. The system of claim 1, wherein the system comprises a detector assembly, comprising:
a plurality of energy integrating detector elements disposed on a substrate to form an array of energy integrating detector elements;
a plurality of energy discriminating detector elements disposed adjacent the plurality of energy integrating detector elements; and
a filtering element disposed adjacent the plurality of energy discriminating detector elements.

12. The system of claim 11, further comprising a detector module having a plurality of detector assemblies disposed on an interconnection substrate.

13. The system of claim 1, further comprising readout electronics in operative association with each of the plurality of energy integrating detector elements and each of the plurality of energy discriminating detector elements, wherein the readout electronics are configured to facilitate reading out signals from each of the plurality of energy integrating detector elements and each of the plurality of energy discriminating detector elements.

14. A detector module comprising a plurality of detector assemblies disposed on an interconnection substrate.

15. The detector module of claim 14, wherein each of the plurality of detector assemblies comprises:
a plurality of energy integrating detector elements disposed on a substrate to form an array of energy integrating detector elements;
a plurality of energy discriminating detector elements disposed adjacent the plurality of energy integrating detector elements; and
a filtering element disposed adjacent the plurality of energy discriminating detector elements.

16. The detector module of claim 14, wherein the plurality of energy discriminating detector elements are arranged in a predetermined direction.

17. The detector module of claim 14, further comprising electronics disposed on the interconnection substrate, wherein the electronics are configured to transmit and receive data and power to detector module.

18. A detector module comprising:
a first layer comprising a plurality of energy integrating detector elements disposed on a first substrate, wherein the plurality of energy integrating detector elements is configured to acquire energy integrating data;
a second layer comprising a filtering element disposed adjacent the first layer, wherein the filtering element is configured to attenuate X-ray spectra; and
a third layer comprising a plurality of energy discriminating detector elements disposed adjacent the second layer and disposed on a second substrate, wherein the plurality of energy discriminating detector elements is configured to acquire energy discriminating data.

19. The detector module of claim 18, further comprising an interconnection substrate configured to facilitate coupling the plurality of energy integrating detector elements and the plurality of energy discriminating detector elements to readout electronics.

20. The detector module of claim 18, wherein the first substrate comprises a scintillator sensor and the second substrate comprises a ceramic substrate.

21. A method of imaging comprising:
obtaining energy integrating image data from a plurality of energy integrating detector elements;
obtaining energy discriminating image data from a plurality of energy discriminating detector elements; and
combining the energy integrating image data and the energy discriminating image data to form combined image data,
wherein the plurality of energy integrating detector elements and the plurality of energy discriminating detector elements are arranged in a spatial relationship to form a hybrid detector, and wherein the plurality of energy integrating detector elements and the plurality of energy discriminating detector elements are configured to obtain respective sets of energy integrating data and energy discriminating data for use in generating an image.

22. The method of claim 21, further comprising processing the combined image data to facilitate generating image data.

23. The method of claim 21, further comprising irradiating the plurality of energy integrating detector elements and the plurality of energy discriminating detector elements with one or more sources of radiation.

24. An imaging system comprising:
one or more sources of radiation configured to emit a stream of radiation toward a patient to be scanned;
a computer configured to generate images with enhanced image quality and to provide tissue composition information;
a detector assembly configured to detect the stream of radiation and to generate one or more signals responsive to the stream of radiation, wherein the detector assembly comprises:
a plurality of energy integrating detector elements configured to acquire energy integrating data;
a plurality of energy discriminating detector elements configured to acquire energy discriminating data,
wherein the plurality of energy integrating detector elements and the plurality of energy discriminating detector elements are arranged in a spatial relationship to form a hybrid detector, and wherein the plurality of energy integrating detector elements and the plurality of energy discriminating detector elements are configured to obtain respective sets of energy integrating data and energy discriminating data for use in generating an image;
a system controller configured to control the rotation of the one or more sources of radiation and the detector assembly and to control the acquisition of one or more sets of projection data from the detector assembly via a data acquisition system; and
a computer system operationally coupled to the one or more sources of radiation and the detector assembly, wherein the computer system is configured to receive the one or more sets of projection data.
